(19) United States
(12) Patent Application Publication
(10) Pub. No.: US 2009/0062046 A1
(43) Pub. Date: Mar. 5, 2009

(54) Belt tensioner with adjustable slider plate and replaceable pulley

(76) Inventor: Robert Lindemann, St. James, NY (US)

Correspondence Address: HOFFMAN, WASSON & GITLER, P.C., Suite 522, 2461 South Clark Street, Arlington, VA, 22202, US

(21) Appl. No.: 11/896,518

(22) Filed: Sep. 4, 2007

(51) Int. Cl. F16H 7/12

(52) U.S. Cl. 474/101

(57) ABSTRACT

The present invention is directed to a versatile belt tensioner comprising a base plate, a slider plate, a pulley secured a unitary post joined to one end of the slider plate, and manually operable adjustment assembly for moving the slider plate and pulley relative to the base plate, to tension a drive belt. The base plate is formed with an inverted, U-shaped downwardly opening guideway, and the slider plate is moved within the guideway relative to the base plate to adjust the position of the pulley relative to the drive belt by way of a manually operable adjustment knob. A bearing extends between the post and the pulley seated thereon, so that the pulley can be replaced to accommodate drive belts of different size and different teeth configurations.

### FIELD OF THE INVENTION

The invention relates generally to belt tensioners for applying, and maintaining, the desired level of tension in a drive belt.

### BACKGROUND OF THE INVENTION

Endless belts, that extend from a drive pulley to a driven pulley, find widespread applications. However, in order for the belt, the pulleys, and the bearings associated therewith, to function satisfactorily for an extended period of time, proper tension must be maintained in the belt, despite wear and tear on the belt. If the tension is too great, the belt may slip and cause friction in the bearings, retaining the pulleys in operative position. If the tension is too little, the belt may sag, or slip, causing unsatisfactory performance of the equipment associated with the drive belt.

The problem of attaining, and maintaining, proper tension in a drive belt has been addressed in numerous ways. One approach is found in U.S. Pat. No. 5,002,518 granted to S. L. Pennatto, wherein one idler pulley 28 in a belt/pulley system, is slidably mounted on a bracket 14. A spring 22, compressed to a fixed distance to provide a known force, is attached to the bracket by a horizontally extending screw 20. The bracket, being initially free to move along surfaces 50 on base 10, transfers the known force to the belt/pulley assembly for providing optimum tension. Once the proper tension of the belt is obtained, the bracket is fixed by tightening vertically extending screw 30. Re-tensioning of the belt, when necessary, is accomplished by loosening, and then re-securing, the bracket.

Another belt tensioner, which finds particular application with timing belts, is shown in U.S. Pat. No. 6,575,858, granted to Michael H. Green et al; such tensioner assumes the form of a spring-loaded, non-active tensioner. The spring 40 is mounted between a base plate 60, and a tensioner arm 20, both of which rotate. A belt tensioner pulley 30 is mounted on the tensioner arm, such that the belt tensioning pulley is adjacent to the drive belt. The tension of the spring causes the tensioner arm to rotate, which causes the belt tensioning pulley to tension the drive belt.

However, known belt tensioners utilize a pulley, of a particular size and possessing teeth of a specific configuration, for each belt drive. Thus, if a belt of a different size, or a belt with teeth of a different configuration must be placed in tension, another belt tensioner, is required. The previously installed belt tensioner must be removed and replaced. The expense of stocking a variety of belt tensioners of different sizes and possessing different configurations is considerable. Also, the down time associated with removing and replacing belt tensioners, particularly in tight quarters and hard to reach locations, imposes an economic penalty upon the operator of the equipment undergoing maintenance. Practical considerations thus dictated the need for more versatile tensioners that could service a range of drive belt sizes, with diverse configurations of teeth on the drive belt.

### BRIEF SUMMARY OF THE INVENTION

The present invention is directed to a versatile belt tensioner comprising a base plate, a slider plate, a pulley secured to one end of the slider plate, and a manually operable adjustment assembly for moving the slider plate and pulley relative to the base plate. The base plate is formed with an inverted, U-shaped downwardly opening guideway, and the slider plate moves within the guideway relative to the base plate to adjust the position of the pulley relative to a drive belt.

The adjustment assembly comprises an upstanding housing on the base plate, an upstanding bracket that defines the L-shape of the slider plate, a horizontally extending shaft with an external helical thread, and a compression spring encircling the shaft. A rotatable, adjustment knob is advanced along the thread on the shaft to move the piston on the slider plate relative to the drive belt, and thus vary the tension applied thereto.

A compression cone is inserted into each end of the compression spring, so that the spring remains in fixed orientation relative to the shaft.

A forwardly opening slot is defined at one end of the base plate, and a rearwardly opening slot is formed at the opposite end of the base plate. An upwardly extending shaft, located on the slider plate, projects upwardly through the forwardly opening slot. A pulley, with a central bore and a sleeve-like bearing, is slipped over the shaft, so that the pulley may cooperate with a drive belt and apply tension thereto.

The enlarged head of a metal stud, projects upwardly from the opposite end of the slider plate, and rests on the side walls of the rearwardly opening slot in the base plate as the slider plate is adjusted relative to the base plate.

The upwardly extending shaft on the slider plate may be inserted upwardly through aligned openings in the slider plate and base plate. A sleeve-like bearing is located in the central opening in each pulley. Alternatively, the sleeve bearing may be fitted over the free end of the fastener. The pulley is releasably engaged with the sleeve bearing and/or the shaft of the fastener, and may be easily removed and replaced by a pulley of a different size and/or a different tooth configuration, better suited to the belt to be tensioned.

Other advantages and objectives released by applicant's sturdy, effective, low cost, and easily installed belt tensioner, ideally suited for use with belts of different sizes and configurations, will occur to the skilled artisan from the following specification, when construed in harmony with the appended drawings.

### BRIEF DESCRIPTION OF THE DRAWINGS

FIG. 1 is a perspective view of a conventional belt tensioner, which is indicated by the legend PRIOR ART;

FIG. 2 is a perspective view of a belt tensioner constructed in accordance with the principles of applicant's invention, with a section broken away for the sake of clarity;

FIG. 3 is a top plan view of the belt tensioner of FIG. 2;

FIG. 4 is an end view of the belt tensioner of FIG. 2;

FIG. 5 is a side view of the belt tensioner of FIG. 2, with sections of the base plate broken away to show the slider plate in its extended position;

FIG. 6 is a side view of the belt tensioner of FIG. 2, with sections of the base plate broken away to show the slider plate in its retracted position; and

FIG. 7 is a schematic view of applicant's belt tensioner applying tension to a drive belt.

### DETAILED DESCRIPTION

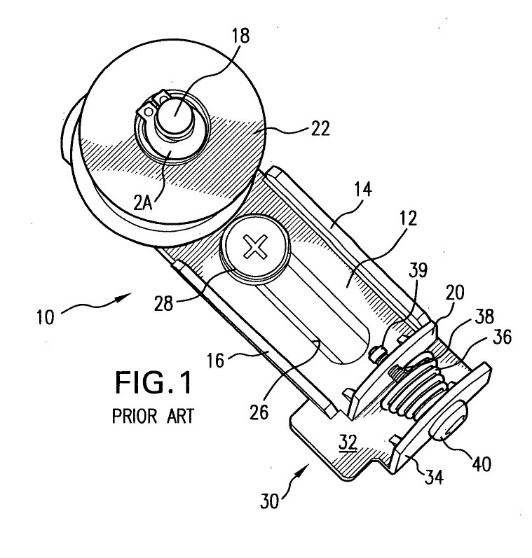

A known belt tensioner, available from York, Inc., and indicated generally by reference numeral 10, is shown in FIG. 1. Tensioner 10 comprises a rectangular body 12, with rails 14, 16 situated along the opposite sides of the body. An upstanding shaft 18 is situated at one end of the body, and a flange 20 is located at the opposite end. Pulley 22 is affixed to shaft 18 by retainer clip 24, which retains the pulley in operative position upon the shaft.

Elongated slot 26 extends along the central portion of body 26, and a fastener 28, such as a screw, with an enlarged head, is adjustable within slot 26. Fastener 28, when tightened, secures the tensioner to a support surface (not shown) and determines the position of pulley 22 relative to a belt to be tightened (also not shown). Tensioning mechanism 30, for biasing pulley 22, comprises end piece 30 with upstanding bracket 34. A coiled compression spring 36 fits over shaft 38, which is externally threaded. Nut 39 is secured on one end of shaft 38. The tension in spring 36 is adjusted by rotating knob 40 situated on the exterior of bracket 32, so that the tension applied to a drive belt is adjusted as the belt ages and wears.

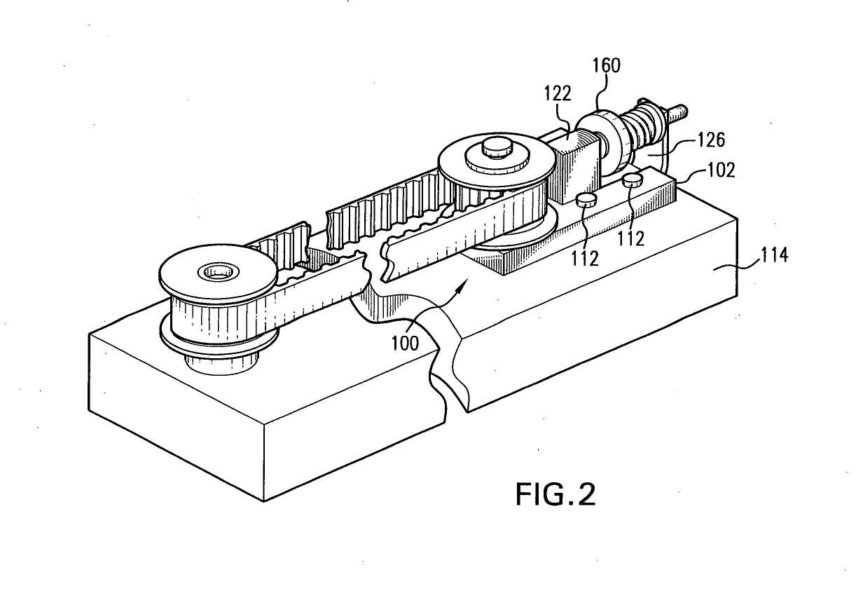

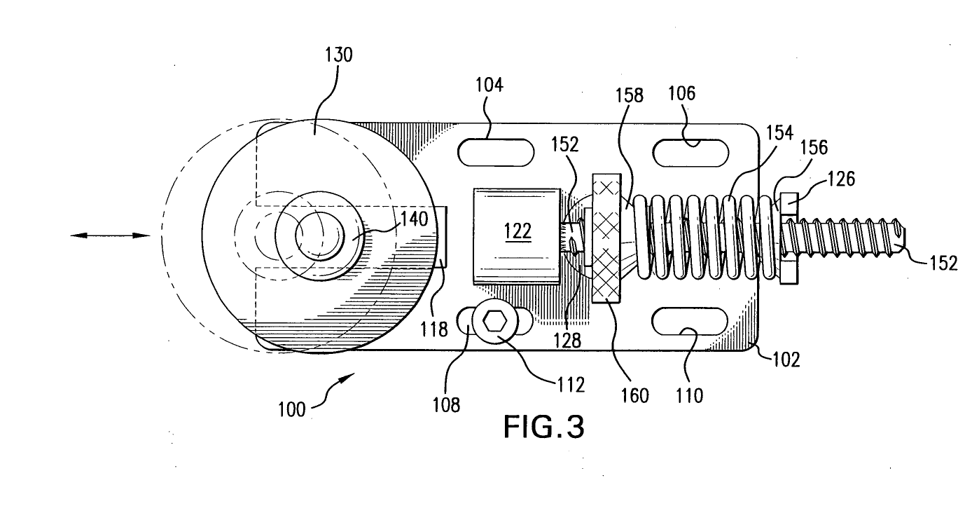

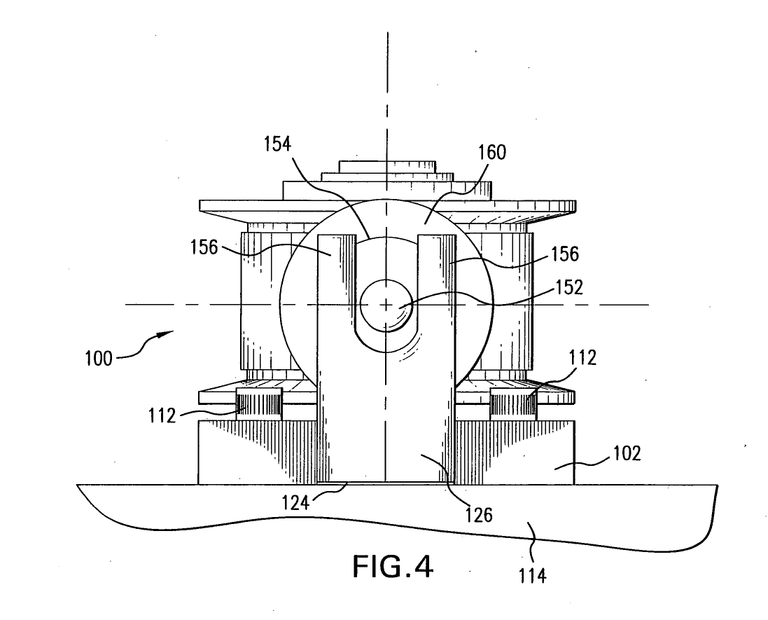

FIGS. 2-6 show applicant's unique belt tensioner, indicated generally by reference numeral 100. Belt tensioner 100 comprises base plate 102 which has slots 104, 106, 108 and 110 formed therein, as shown in FIG. 3. Fasteners 112 are passed through the slots and threaded into engagement with supporting surface 114 to anchor the tensioner in fixed position. The fasteners may utilize heads with sockets for Allen wrenches, so that the fasteners may be readily installed. Base plate 102 is formed of a sturdy plastic, and includes a centrally located guideway 116. A forwardly opening rectangular slot 118 is located at one end of the base plate, and a similar, rearwardly opening rectangular slot 120 is located at the opposite end of the base plate. An upwardly projecting housing 122 is located between slots 118 and 120 on the upper surface of base plate 102.

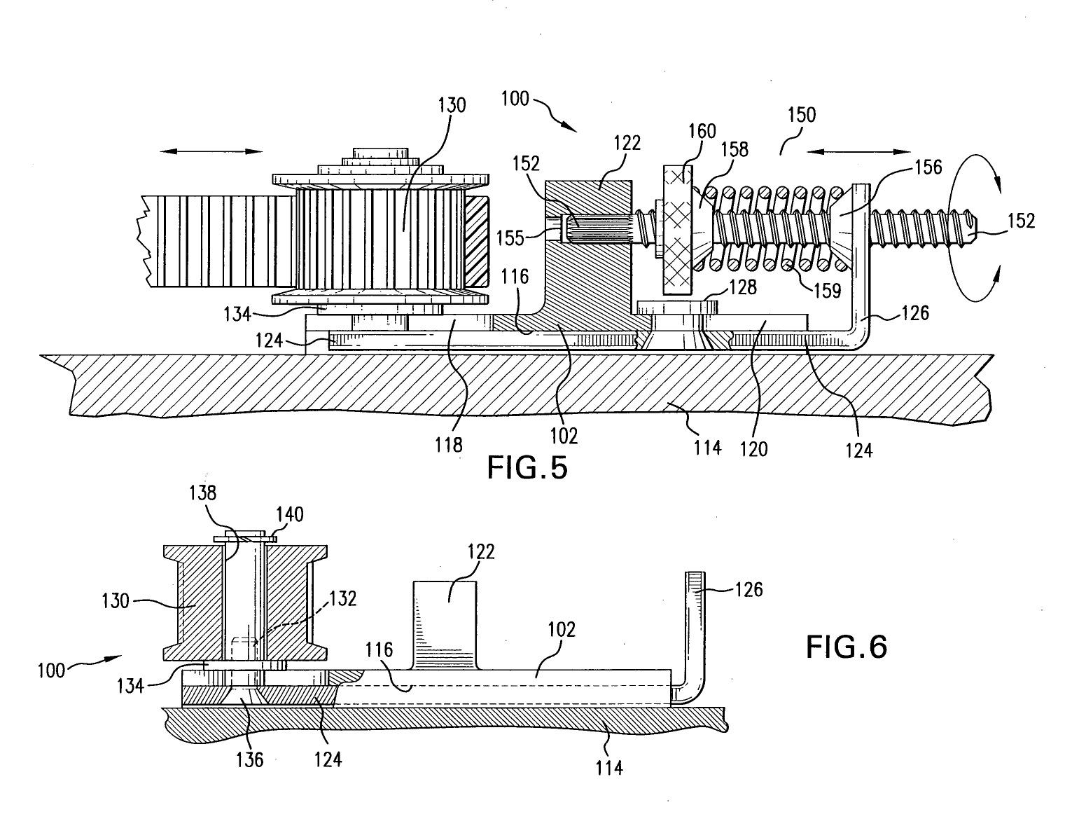

The body of slider plate 124, glides within guideway 116 relative to base plate 102, as shown in FIGS. 5 and 6. The slider plate is formed from a lightweight metal, such as aluminum. An upstanding bracket 126 is situated at one end of the body of slider plate 124, perpendicular to the body, to form an L-shaped member, when viewed in side elevation. Metal stud 128 passes through slider plate 124, and extends upwardly to engage the sidewalls of rearwardly opening slot 120 in base plate 102 to maintain slider plate 124 in proper relationship to base plate 102.

Pulley 130 is situated at the end of slider plate 124 remote from bracket 126; the pulley 130 is moved within slot 118 in base plate 102. Post 132 of one piece construction passes upwardly through an aperture in slider plate 124 into slot 118. Spacer 134, which is greater in diameter than the post 132, rides along the spaced sidewalls of slot 118, as suggested by the dotted outline in FIG. 3. Spacer 134 is formed integrally with post 132. Screw 136 extends into a threaded cavity in post 132, and retains the post in fixed position. Sleeve bearing 138 extends axially through pulley 130, and slips over the free end of post sleeve bearing 132. Sleeve bearing 138 enables pulley 130 to rotate, over extended periods of time, with minimum wear and negligible heat build-up.

A split retainer ring 140 may be snapped over the upper end of pulley 130 to retain same aligned with the drive belt to be tensioned. When the tensioner is used in conjunction with another belt, of different size and/or tooth configuration, retainer ring 140 is removed, the mounted pulley 130 is removed, and a different pulley is slipped over sleeve bearing 138 and the free end of post 132.

Adjustment mechanism 150, which shifts slider plate 124 relative to base plate 102, is visible, with varying degrees of detail, in FIGS. 2, 3, 4 and 5. As shown in FIG. 5, elongated shaft 152, which has a helical thread on its exterior surface, extends through housing 122, at one end, and passes through bracket 126 at its opposite end. Bracket 126 includes spaced fingers 154, 156 at its upper end, and shaft 152 extends therethrough. The opposite end of shaft 152, which extends in a horizontal plane, is press-fitted, or otherwise secured, within an axial passage 155 in housing 122. Coil spring 159 encircles shaft 152, and conical collars 157, 158 retain the spring in alignment relative to shaft 152.

Adjustment knob 160 is rotated to shift slider plate 124 relative to base plate 102, thereby drawing post 132 with pulley 130 mounted on post 132 into forward slot 118 on base plate 102. After the fastener and pulley are moved to the desired location, compression spring 159 applies tension to the endless belt to compensate for the wear and tear on the drive belt under diverse operating conditions and over an extended period of time.

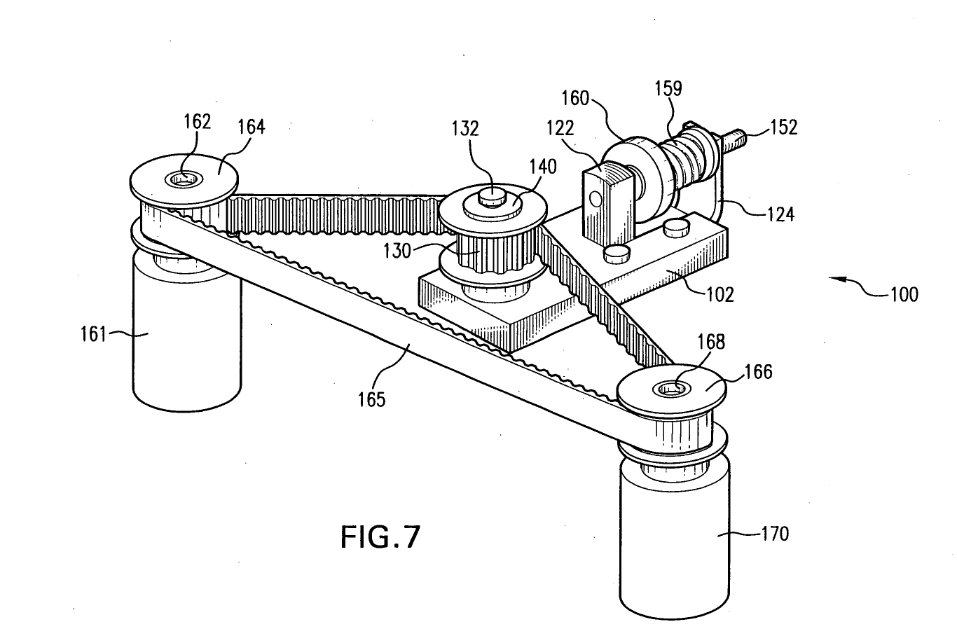

FIG. 7 shows the manner in which applicant's belt tensioner 100 may be utilized. Drive motor 161 delivers power to shaft 162, to rotate pulley 164, which is mounted upon shaft 162. The power supplied by drive motor 161 is delivered, via endless drive belt 165, to pulley 166, seated upon shaft 168, to rotate driven member 170. Drive motor 161 and driven member 170 are both maintained in fixed position. The endless drive belt is also trained about pulley 130 on belt tensioner 100. The position of pulley 130, within forward slot 118 in base plate 102, is adjusted to maintain the endless belt under the degree of tension needed to maintain the drive belt in satisfactory operating condition. The spring 159 maintains the original belt tension within a specific operating range regardless of belt length change due to wear and thermal conditions. A replacement drive belt may be installed by shifting slider plate 124 within guideway 116 in base plate 102 to disengage belt 165 from tensioner 100. A replacement drive belt, of the same configuration, may be installed, and belt tensioner 100 may be re-engaged to apply tension to the replacement belt, by virtue of adjustment knob 160.

Alternatively, if a replacement belt of a different size, and/or a different tooth configuration is selected, pulley 130 is replaced, also. The sleeve bearing 138 of the new, and different pulley, is also slipped over the free end of post 132. Belt tensioner 100 is then manually adjusted to apply the desired degree of tension to the replacement belt and the transmission of driving force achieved by endless belt 165 is quickly restored.

Numerous modifications and revisions to applicant's belt tensioner will readily become apparent to the skilled artisan. Ball bearings may be used in lieu of sleeve bearing 138. A rivet may be used in lieu of flat-headed screw 136 to secure post 132 in fixed position. Spacer 134 may be formed as a separate component that is slipped onto post 132. An idler may be pressed against belt 165 in FIG. 7 to insure proper tracking of the belt. Consequently, the appended claims should be literally construed in a manner consistent with applicant's inventive efforts, and should not be limited to their literal terms.

I claim:

1. A belt tensioner comprising:
a) a base plate,
b) means for securing said base plate to a supporting surface,
c) a guideway formed within said base plate,
d) a first slot formed at one end of said base plate and a second slot formed at the opposite end thereof,
e) a slider plate moveable within said guideway relative to said base plate,
f) said slider plate comprising a body with a bracket defined at one end thereof,
g) an upstanding post at the end of said body of said slider plate remote from said bracket,
h) a pulley removably mounted upon said post,
i) fastener means passing through aligned openings in said slider plate and said base plate to maintain said plates in operative relationship, and
j) manually operable adjustment means situated between said slider plate and said base plate for moving said slider plate relative to said base plate to thereby alter the position of said post, and the pulley mounted thereon, within the first slot on said base plate.

2. A belt tensioner as defined in claim 1, wherein said post possesses a one piece construction.

3. A belt tensioner as defined in claim 2 wherein a threaded cavity is defined in the lower end of said post, and a fastener extends upwardly from the slider plate into the said cavity to secure said post in position.

4. A belt tensioner as defined in claim 2, wherein a spacer is secured about said post, and said spacer rides along the sidewalls of said second slot.

5. A belt tensioner as defined in claim 1, wherein said pulley includes a sleeve bearing, said sleeve bearing fitting over the free end of the post to retain the pulley in operative position.

6. A belt tensioner as defined in claim 1, wherein a housing is located atop said base plate, and said adjustment means comprises a horizontally extending shaft, helical threads on the exterior of said shaft, and a rotatable knob that is advanced along said thread to apply force to said bracket on said slider plate to move same relative to said base plate.

7. A belt tensioner as defined in claim 6, further including a spring that encircles said horizontally extending shaft, and conical members located at opposite ends of said spring to maintain same about said shaft.

8. A belt tensioner as defined in claim 6, wherein an axial recess is formed in said housing, and said bracket on said slider plate has spaced fingers defined at its upper end, one end of said shaft being fitted into said axial recess and the opposite end of said shaft extending between the spaced fingers on said bracket.

9. A belt tensioner as defined in claim 1, wherein said means for maintaining said slider plate and said base plate together comprises a metal stud with an enlarged head, said enlarged head moving within said second slot within said base plate.
